(19) United States
(12) Patent Application Publication
(10) Pub. No.: US 2008/0268925 A1
(43) Pub. Date: Oct. 30, 2008

(54) ANTENNA MODULE FOR A MOBILE PHONE

(76) Inventor: Chia-Lun TANG, Pa-Te City (TW)

Correspondence Address: SINORICA, LLC, 528 FALLSGROVE DRIVE, ROCKVILLE, MD, 20850, US

(21) Appl. No.: 11/741,020

(22) Filed: Apr. 27, 2007

(51) Int. Cl. H04M 1/00

(52) U.S. Cl. 455/575.7

(57) ABSTRACT

An antenna module for a mobile apparatus, wherein an antenna, a speaker and/or a camera are integrated in a housing; the antenna module is designed in the mode of optimal modularization to reduce interference of the speaker upon the antenna, thus the feature of the antenna can be improved; and the cost of product assembling and the period of product development can be reduced.

### BACKGROUND OF THE INVENTION

1. Field of the Invention

The present invention relates to an antenna module for a mobile apparatus, and especially to an antenna module for integrating an antenna, a speaker and a camera of a mobile apparatus such as a mobile phone, a notebook etc. in a housing by optimal modularization.

2. Description of the Prior Art

Elements including an antenna, a speaker and a camera etc. of a mobile apparatus used presently are all separately provided in the mobile apparatus, this renders inferior of efficiency of space utilization.

FIG. 1 shows partial part allocation of a kind of mobile phone sold in the markets; wherein an antenna 92, a speaker 93 and a camera 94 are separately provided above a circuit board 91 of a housing.

Generally, during a period of product development, elements are manufactured independently without considering the problem of electromagnetic interference; therefore, difficulty of feature adjustment in the later period of product development of mobile apparatuses thus is often increased; and improvement is required.

### SUMMARY OF THE INVENTION

Thereby, the present invention provides an antenna module for a mobile apparatus, wherein an antenna, a speaker and/or a camera are integrated in a housing; the antenna module is designed in the mode of optimal modularization to reduce interference of the speaker upon the antenna, thus the feature of the antenna can be improved.

The main object of the present invention is to provide an antenna module for a mobile apparatus, wherein an antenna, a speaker and/or a camera around the antenna are designed in the mode of optimal modularization to reduce waste of space of the mobile apparatus; this meets the tendency of making products light, thin and small.

Another object of the present invention is to provide an antenna module for a mobile apparatus, wherein three elements including an antenna, a speaker and/or a camera are integrated into a single module; this can reduce the cost of product assembling and shorten the period of product development.

Another object of the present invention is to provide an antenna module for a mobile apparatus, wherein the module is designed in the mode of optimal modularization for dealing with the problem of interference on the antenna by the ambient elements, (particularly, the speaker is most influenceable to the radiation effect of the antenna; such optimal modularization can be benefit to improvement of the feature of the antenna.

A further object of the present invention is to provide an antenna module for a mobile apparatus, wherein after modularization of the antenna and its ambient elements, the feature of the mobile apparatus such as the impedance of the antenna, the efficiency of the antenna, the total radiated power (TRP), the total isotropic sensitivity (TIS), the hearing aid compatibility (HAC) and the specific absorption rate (SAR) etc. can be elevated.

The present invention will be apparent in its structure and functions after reading the detailed description of the preferred embodiment thereof in reference to the accompanying drawings.

### BRIEF DESCRIPTION OF THE DRAWINGS

FIG. 1 is a schematic view showing internal partial part allocation of a conventional mobile phone;

FIG. 2 is an anatomic perspective view of the present invention;

FIG. 3 is an anatomic perspective view of the present invention seeing in another direction;

FIG. 4 is a perspective view showing the present invention as of FIG. 2 after assembling;

FIG. 5 is a perspective view showing the present invention as of FIG. 3 after assembling;

FIG. 6 is a schematic view showing application of the present invention on a notebook;

FIG. 7 is a schematic view showing application of the present invention on a mobile phone.

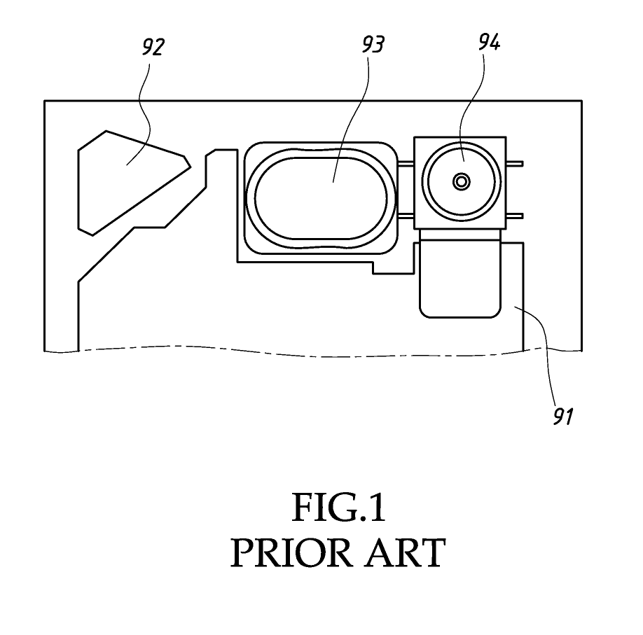

### DETAILED DESCRIPTION OF THE PREFERRED EMBODIMENT

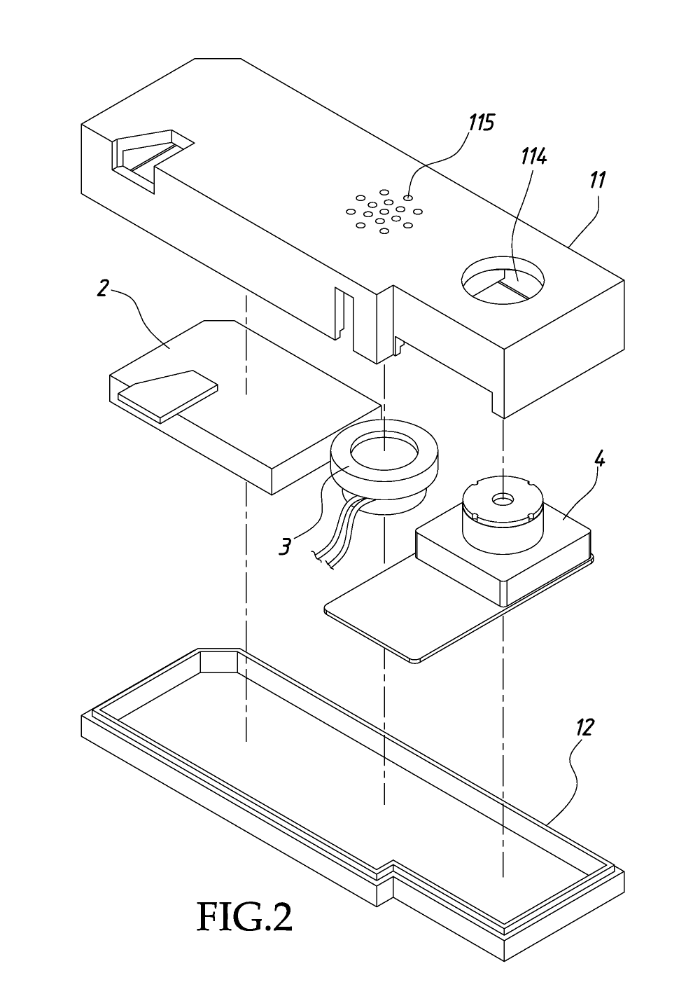

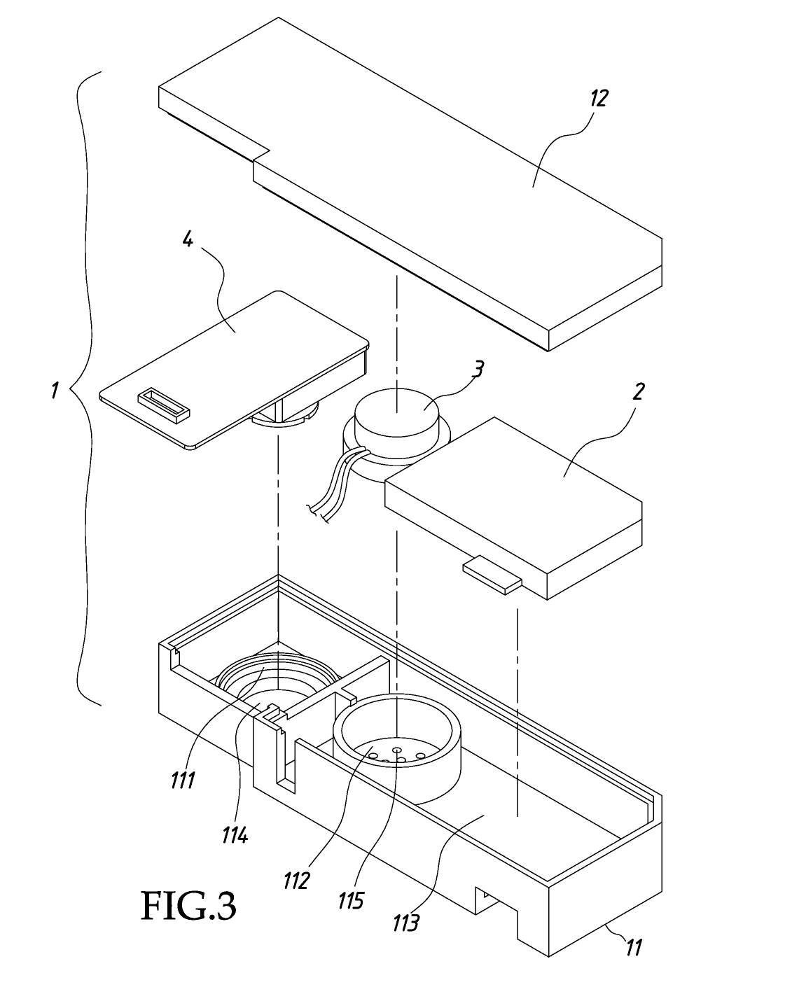

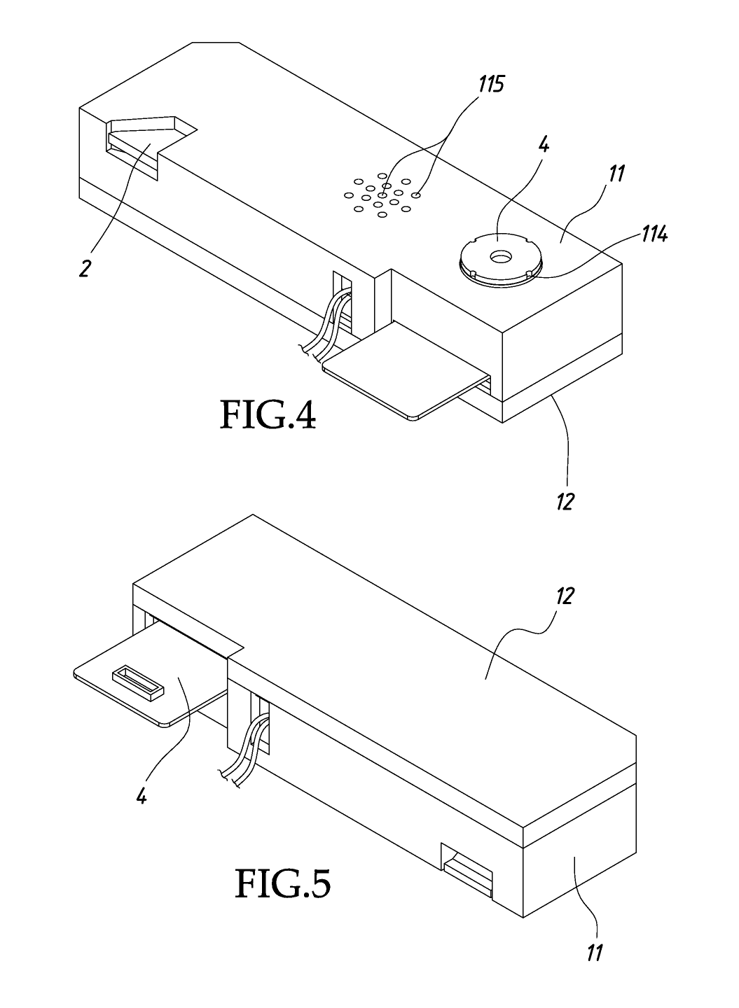

Referring to FIGS. 2-5, the antenna module for a mobile apparatus of the present invention as shown mainly includes a housing 1 and elements integrated therein including an antenna 2, a speaker 3 and/or a camera 4; in the drawings, the speaker 3 and the camera 4 are both included for description.

The housing 1 is composed of an upper cover 11 and a bottom lid 12; a first receiving room 111, a second receiving room 112 and a third receiving room 113 are formed in the housing 1.

The first receiving room 111 is for assembling the camera 4 and is formed thereon a round hole 114 for taking photos by the camera 4. The second receiving room 112 is for assembling the speaker 3 and is formed thereon a plurality of sound output holes 115 for sending out sounds by the speaker 3. The third receiving room 113 is for assembling the antenna 2. The third receiving room 113 for assembling the antenna 2 is not limited to a determined space; in practical manufacturing, the speaker 3 and the camera 4 are fixed in the first place, then the antenna 2 is laid out in the housing 1 in the mode of optimal modularization to mate with the space given.

The present invention has the antenna 2, the speaker 3 and the camera 4 designed in the mode of modularization to make the three elements get close to compact the entire structure and to reduce waste of space of the mobile apparatus; this meets the tendency of making products light, thin and small. Meantime, the three elements including the antenna 2, the speaker 3 and the camera 4 are integrated into a single module to reduce the cost of product assembling and shorten the period of product development, and to reduce interference upon the antenna 2, thus the feature of the antenna 2 can be improved.

Moreover, after modularization of the antenna 2 and its ambient elements, the communication feature of the mobile apparatus such as the impedance of the antenna 2, the efficiency of the antenna 2, the total radiated power (TRP), the total isotropic sensitivity (TIS), the hearing aid compatibility (HAC) and the specific absorption rate (SAR) etc. can be elevated.

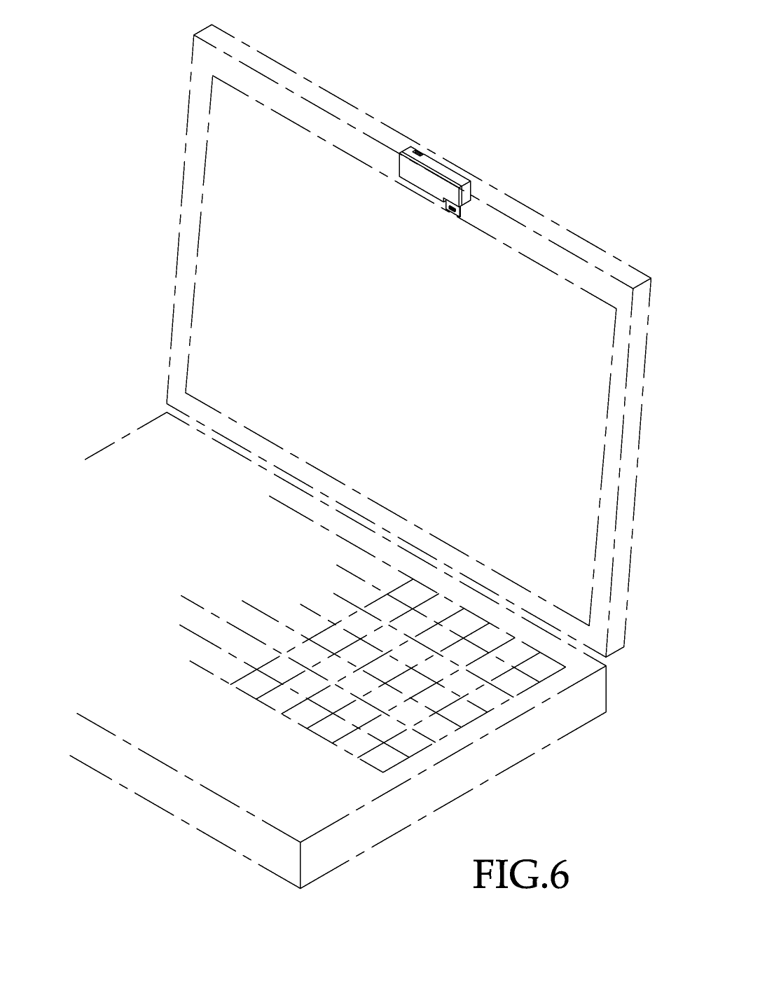

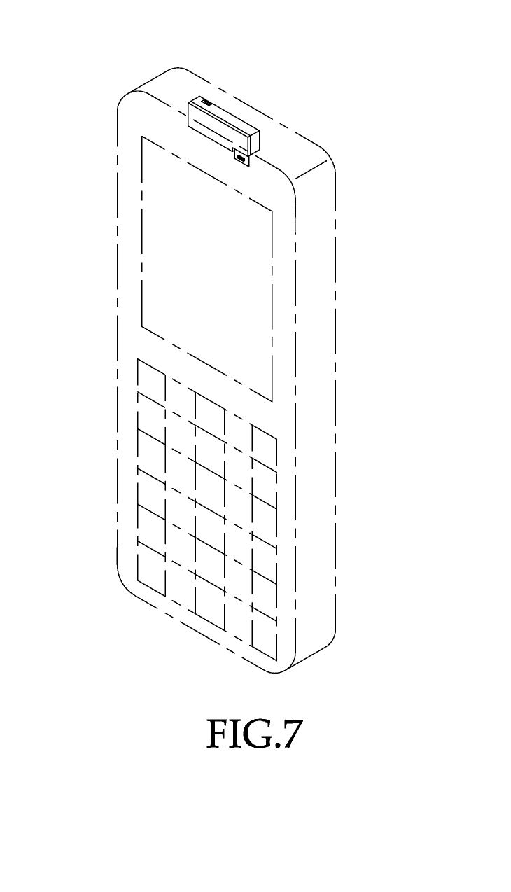

As shown in FIG. 6 which is a schematic view showing application of the present invention on a notebook, a notebook used presently is built therein with a digital camera, an antenna is also provided in a space neighboring to the camera; hence the antenna module is very suitable for using here. FIG. 7 is a schematic view showing application of the present invention on a mobile phone.

The embodiment given is only for illustrating the present invention, and not for giving any limitation to the scope of the present invention. It will be apparent to those skilled in this art that various modifications or changes without departing from the spirit of this invention shall also fall within the scope of the appended claims.

Having thus described the technical structure of my invention with practicability and improvement, what I claim as new and desire to be secured by Letters Patent of the United States is:

1. An antenna module for a mobile apparatus, wherein a speaker and/or a camera are integrated in a housing; said antenna module is designed in a mode of optimal modularization to reduce interference of said speaker upon said antenna, thus feature of said antenna is improved.

2. The antenna module for a mobile apparatus as defined in claim 1, wherein said housing is composed of an upper cover and a bottom lid; said upper cover includes:
a first receiving room for assembling said camera and being formed thereon a round hole for taking photos by said camera;
a second receiving room for assembling said speaker and is formed thereon a plurality of sound output holes for sending out sounds by said speaker;
a third receiving room for assembling said antenna, said antenna is laid out in said housing in a mode of optimal modularization to mate with a space given.
